(19) United States
(12) Patent Application Publication
(10) Pub. No.: US 2006/0017254 A1
(43) Pub. Date: Jan. 26, 2006

(54) Vehicle-towed trailer with independent suspension

(76) Inventor: Robert A. Kulick, Southgate, MI (US)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 11/170,984

(22) Filed: Jun. 30, 2005

Related U.S. Application Data
(60) Provisional application No. 60/584,053, filed on Jun. 30, 2004.

(51) Int. Cl. B60G 21/05

(52) U.S. Cl. 280/124.128

(57) ABSTRACT

A vehicle-towed trailer includes a trailer frame, at least two wheels, and an independent suspension system securing each wheel to the frame. The independent suspension system includes a rotatable suspension rod supported by the frame and a trailing arm secured to the suspension rod. The trailing arm is adapted to pivot relative to the vehicle frame as the suspension rod rotates and includes a hub adapted to support one of the wheels. A bellcrank is secured to the suspension rod and is adapted to pivot relative to the vehicle frame as the suspension rod rotates. The bellcrank is spaced angularly relative to the trailing arm about the axis of the suspension rod. A spring member is pivotably secured on one end to the frame and on the other end to the bellcrank. The spring member is compressed and extended as the bellcrank pivots relative to the vehicle frame.

### CROSS-REFERENCE TO RELATED APPLICATIONS

This application claims priority to U.S. provisional application 60/584,053 filed on Jun. 30, 2004, which is incorporated herein by reference in its entirety.

### BACKGROUND OF THE INVENTION

1. Field of the Invention

The present invention relates to vehicle-towed trailers and more particularly to vehicle-towed trailers having an independent suspension system.

2. Description of the Related Art

Vehicle-towed trailers typically include a rigid axle on which a pair of wheels are rotatably supported. The body of the trailer is supported above the axle by leaf springs. Trailers that include more than one rigid axle generally support the axles using a common set of leaf springs. Since each wheel shares an axle with another wheel, and since two or more axles generally share a common set of leaf springs, movement of any one wheel is not truly independent of the other wheels on the trailer. Accordingly, many trailers including the aforementioned suspension structure are limited to “on-road” operation or other operating conditions that do not require independent movement of each wheel. The present invention overcomes the limitations of prior art vehicle-towed trailers that do not permit independent movement of each wheel.

### SUMMARY OF THE INVENTION

A vehicle-towed trailer is provided that includes a trailer frame, at least two wheels, and an independent suspension system securing each wheel to the frame. The independent suspension system includes a rotatable suspension rod supported by the frame and a trailing arm secured to the suspension rod. The trailing arm is adapted to pivot relative to the vehicle frame as the suspension rod rotates. The trailing arm includes a hub adapted to support one of the wheels. A bellcrank is secured to the suspension rod and adapted to pivot relative to the vehicle frame as the suspension rod rotates. The bellcrank is spaced angularly relative to the trailing arm about the axis of the suspension rod. A spring member is pivotably secured on one end to the frame and on the other end to the bellcrank. The spring member is adapted to be compressed and extended as the bellcrank pivots relative to the vehicle frame. Other aspects of the invention will be apparent to those skilled in the art after review of the drawings and detailed description provided below.

### BRIEF DESCRIPTION OF THE DRAWINGS

Embodiments of the invention will now be described, by way of example, with reference to the accompanying drawings, wherein:

FIG. 1 is a side view of a vehicle-towed trailer according to an embodiment of the present invention;

FIG. 2 is a side view of the trailer of FIG. 1 with the wheels removed to expose an independent suspension system in a compressed state;

FIG. 3 is a side view of the trailer of FIG. 1 with the wheels removed to expose the independent suspension system in an extended state;

FIG. 4 is a perspective view of the trailer shown in FIGS. 1-3 with a frame rail from one side of the trailer removed to further expose the independent suspension system;

FIG. 5 is a perspective view of an independent suspension system according to an embodiment of the present invention;

FIG. 6 is a detailed view of FIG. 2, showing the independent suspension system in a compressed state;

FIG. 7 is a perspective view of the independent suspension system shown in FIG. 6;

FIG. 8 is a detailed view of the trailer of FIG. 3, showing the independent suspension system in an extended state; and

FIG. 9 is a perspective view of the independent suspension system shown in FIG. 8.

### DETAILED DESCRIPTION OF THE INVENTION

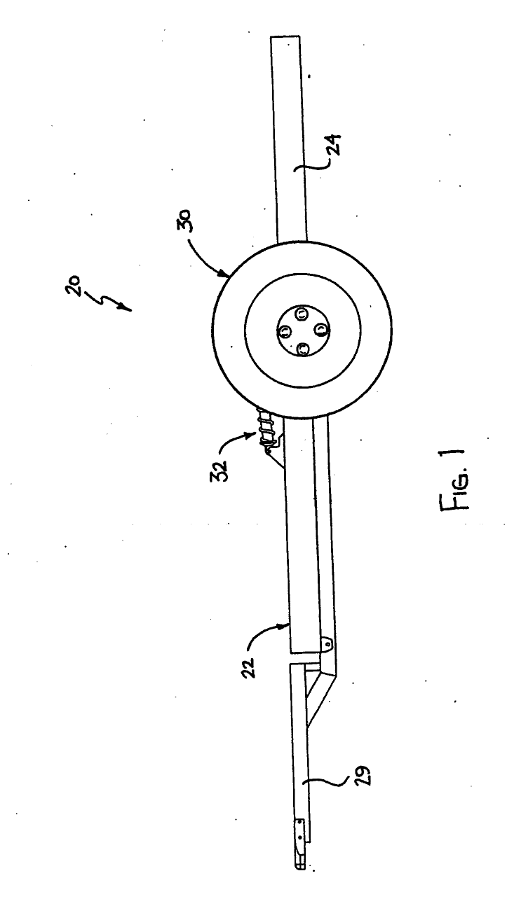

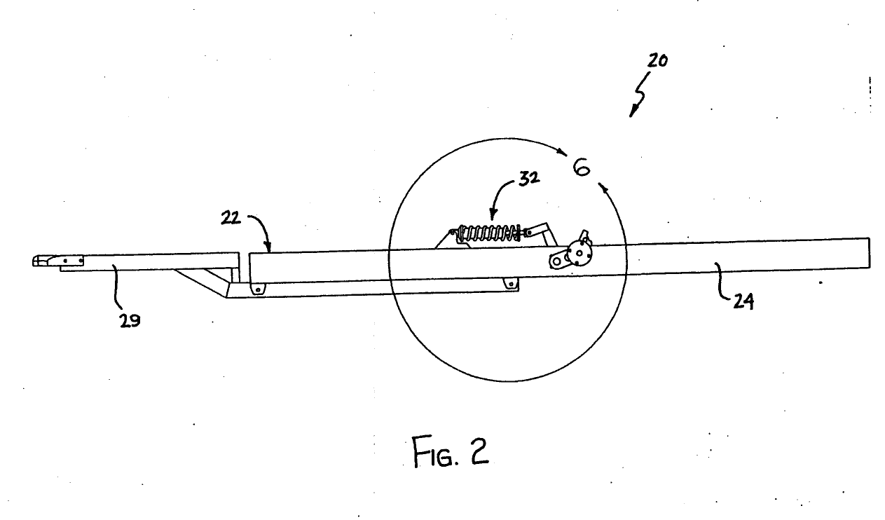

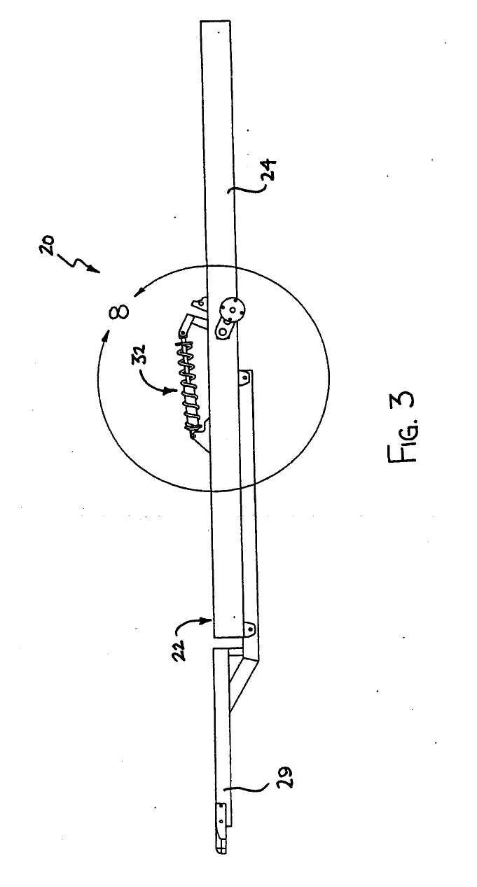

Referring to FIGS. 1-4, a vehicle-towed trailer 20 according to an embodiment of the present invention is shown. Trailer 20 includes a frame 22 having a pair of longitudinally extending frame rails 24. Frame rails 24 are interconnected by at least one transversely mounted cross-member 26 upon which a load floor 28 is supported (see, e.g., FIG. 4). A connecting member 29 is secured to frame 22 and functions to connect trailer 20 to the towing vehicle (not shown). Trailer 20 also includes at least one wheel 30 positioned outwardly of each frame rail 24 and supported on frame 22 by an independent suspension system 32. It will be appreciated after further description of independent suspension system 32 that frame 22 and connecting member 29 are not limited to the configurations illustrated in FIGS. 1-4, and that other frame and connecting member configurations that support the use and operation of independent suspension system 32 are within the scope of the present invention.

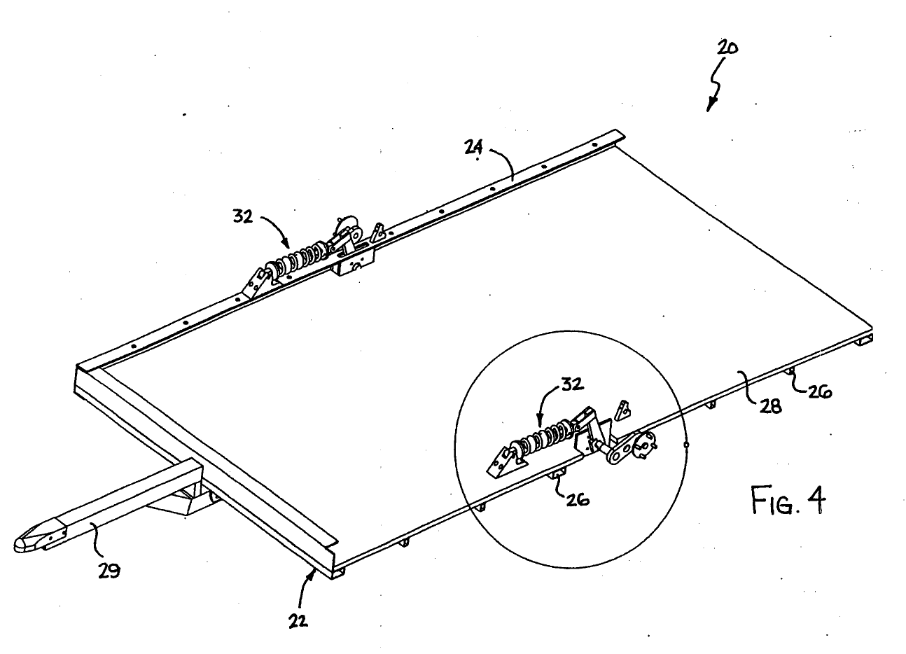

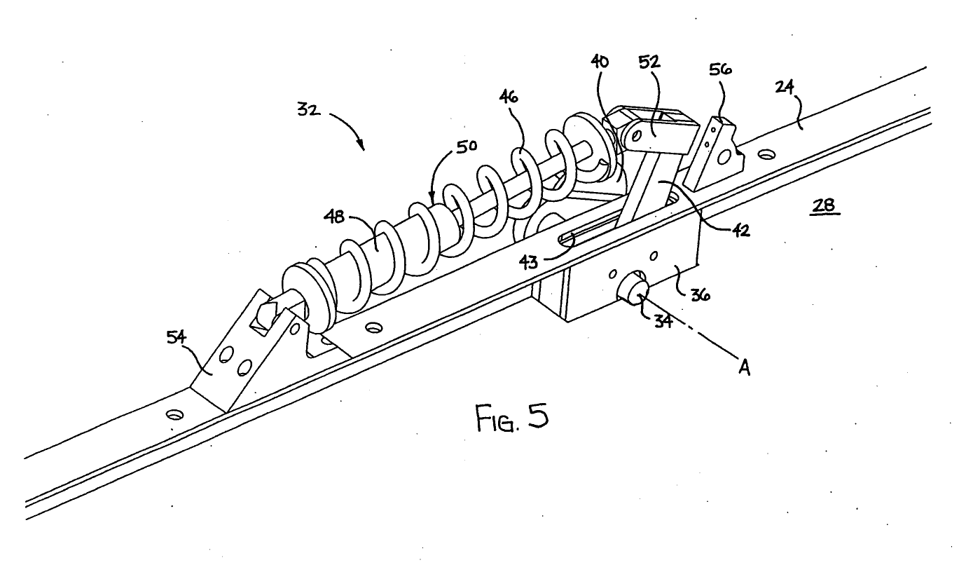

Referring to FIGS. 5-9, an embodiment of independent suspension system 32 is shown in detail. As a preliminary matter, suspension system 32 permits movement of its supported wheel 30 in a manner that is completely independent of the movement of the other wheel(s). To facilitate this operation, an embodiment of suspension system 32 includes a rotatable suspension rod 34 that is supported proximate one of its ends by frame rail 24 and proximate its other end by a support flange 36 secured to and positioned generally orthogonal to load floor 28. A portion of suspension rod 34 extends through frame rail 24 and is secured to a trailing arm 38 that pivots about a longitudinal axis A-A (see FIGS. 5 and 7) of suspension rod 34 as suspension rod 34 rotates. Trailing arm 38 extends generally perpendicular to suspension rod 34 and supports a rotatable wheel hub 40 at some distance removed from suspension rod 34. A bearing (not shown) may be provided between wheel hub 40 and trailing arm 38 to facilitate rotation of wheel hub 40.

With further reference to FIGS. 5-9, suspension system 32 also includes a bellcrank 42 secured to suspension rod 34. As shown in FIG. 5, bellcrank 42 extends through an elongated opening 43 in the generally C-shaped frame rail 24 between support flange 36 and trailing arm 38. In an embodiment, a cap 44 is attached to bellcrank 42 using a pair of fasteners, such as threaded bolts, to sandwich suspension rod 34 therebetween. When properly secured to suspension rod 34, bellcrank 42 pivots about the axis A-A of suspension rod 34 as suspension rod 34 rotates.

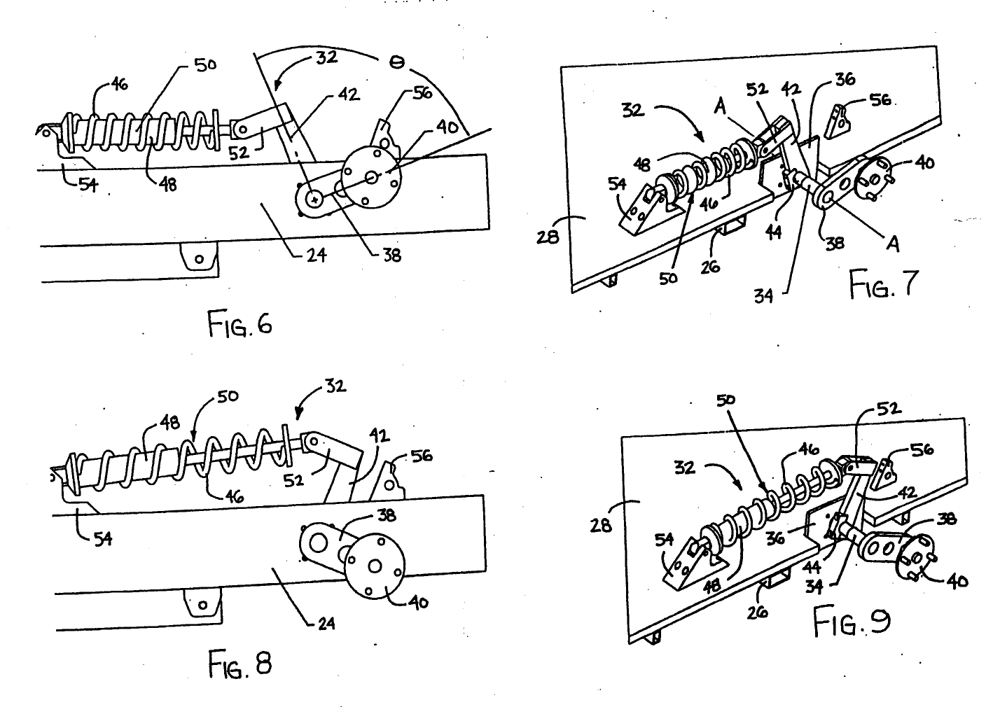

As shown in FIGS. 6 and 8, bellcrank 42 is positioned on suspension rod 34 such that an angle θ exists between trailing arm 38 and bellcrank 42 about the axis A-A of suspension rod 34 (see FIG. 6). In the illustrated embodiment, θ is about 90°; however, θ may be between about 80° and 110° depending on the desired ground clearance and the diameter of the wheel 30 attached to hub 40.

To permit movement of wheel 30 about suspension rod 34 and to dampen this movement, independent suspension system 32 may include a spring member 46 and a damper member 48, respectively. In a particular configuration, spring member 32 includes a compression spring and damper member 34 includes a gas or oil-filled damper.

In an embodiment, spring member 46 and damper member 48 are combined into a shock absorber 50 that is fixed on one end to frame rail 24 (or other structural component of trailer 20) and on the other end to bellcrank 42. In a particular configuration, shock absorber 50 is pivotably attached on one end to an extension arm 52 that is secured to bellcrank 42, and on the other end to an anchor member 54 that is fixed to frame rail 24 (or other structural component of trailer 20). In this manner, shock absorber 50 is free to pivot between anchor member 54 and bellcrank 42 as it is extended and compressed. Trailer 20 may also include a bump-stop 56 proximate each bellcrank 42 to limit the amount of travel of bellcrank 42 and, accordingly, the extension of shock absorber 50.

It will be appreciated that in some “light-duty” applications a damper member 48 may not be needed. However, in other applications, if suspension system 32 were equipped with just spring member 46, wheel 30 may bounce up and down several times after each bump. When compressed by a bump, damper member 48 dissipates the energy that is stored in spring member 46 and prevents the suspension from bouncing out of control.

It will also be appreciated the spring member 46 and damper member 48 may not necessarily be incorporated into a shock absorber 50. Alternatively, spring member 46 and damper member 48 may be separately attached to bellcrank 42 and frame rail 24 (or other structural component of trailer 20). Additionally, while spring member 46 and damper member 48 are shown as being mounted above frame rail 24, spring member 46 and damper member 48 may also be mounted below frame rail 24, provided the trailer wheels 30 are sized to allow the necessary ground clearance for operation of the suspension system.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A vehicle-towed trailer comprising:
a trailer frame;
at least two wheels; and
an independent suspension system securing each wheel to the frame, the independent suspension system including:
a rotatable suspension rod supported by the frame;
a trailing arm secured to the suspension rod and adapted to pivot relative to the vehicle frame as the suspension rod rotates, the trailing arm including a hub adapted to support one of the wheels;
a bellcrank secured to the suspension rod and adapted to pivot relative to the vehicle frame as the suspension rod rotates, the bellcrank being spaced angularly relative to the trailing arm about the axis of the suspension rod; and
a spring member pivotably secured on one end to the frame and on the other end to the bellcrank, the spring member adapted to be compressed and extended as the bellcrank pivots relative to the vehicle frame.

2. The trailer of claim 1, wherein the independent suspension system further includes a damper member.

3. The trailer of claim 2, wherein the spring member and damper member each form a portion of a shock absorber.

4. The trailer of claim 1, wherein the bellcrank is spaced angularly relative to the trailing arm at an angle of about 90°.

5. The trailer of claim 1, wherein the bellcrank is spaced angularly relative to the trailing arm between an angle of about 80° and 110°.

6. The trailer of claim 1, wherein the spring member is positioned above the vehicle frame.

7. The trailer of claim 1, wherein the spring member is positioned below the vehicle frame.

8. The trailer of claim 1, wherein the suspension rod extends through the vehicle frame.

9. The trailer of claim 1, further including a bump-stop for limiting movement of the bellcrank.

10. A vehicle-towed trailer comprising:
a trailer frame including at least two longitudinally extending frame rails;
at least two wheels; and
an independent suspension system securing each wheel to the frame, the independent suspension system including:
a rotatable suspension rod supported by the frame and extending through one of the frame rails;
a trailing arm secured to the suspension rod and adapted to pivot relative to the vehicle frame as the suspension rod rotates, the trailing arm including a hub adapted to support one of the wheels;
a bellcrank secured to the suspension rod and adapted to pivot relative to the vehicle frame as the suspension rod rotates, the bellcrank being spaced angularly relative to the trailing arm about the axis of the suspension rod; and
a shock absorber pivotably secured on one end to one of the frame rails and on the other end to the bellcrank, the shock absorber adapted to be compressed and extended as the bellcrank pivots relative to the vehicle frame.

11. The trailer of claim 10, wherein the shock absorber includes a spring member and a damper member.

12. The trailer of claim 10, wherein the bellcrank is spaced angularly relative to the trailing arm between an angle of about 80° and 110°.

13. The trailer of claim 10, wherein the bellcrank is spaced angularly relative to the trailing arm at an angle of about 90°.

14. The trailer of claim 10, wherein the shock absorber is positioned above the vehicle frame.

15. The trailer of claim 10, wherein the shock absorber is positioned below the vehicle frame.

16. The trailer of claim 10, further including a bump-stop for limiting movement of the bellcrank.

17. A vehicle-towed trailer comprising:
a trailer frame including at least two longitudinally extending frame rails;
at least two wheels; and
an independent suspension system securing each wheel to the frame, the independent suspension system including:
a rotatable suspension rod supported by the frame;
a trailing arm secured to the suspension rod and adapted to pivot relative to the vehicle frame as the suspension rod rotates, the trailing arm including a hub adapted to support one of the wheels;
a bellcrank secured to the suspension rod and adapted to pivot relative to the vehicle frame as the suspension rod rotates, the bellcrank extending through an opening in the frame rail and being spaced angularly relative to the trailing arm about the axis of the suspension rod; and
a shock absorber pivotably secured on one end to one of the frame rails and on the other end to the bellcrank, the shock absorber adapted to be compressed and extended as the bellcrank pivots relative to the vehicle frame.
